(19) United States
(12) Patent Application Publication
(10) Pub. No.: US 2020/0039504 A1
(43) Pub. Date: Feb. 6, 2020

(54) Method and Apparatus for Controlling a Vehicle

(71) Applicant: ARRIVAL LIMITED, Banbury Oxfordshire (GB)

(72) Inventors: Christoforos Chatzikomis, Guildford Surrey (GB); Patrick Gruber, Guildford Surrey (GB); Aldo Sorniotti, Guildford Surrey (GB); Mazuir SHAH, Banbury Oxfordshire (GB); Matthew Bastin, Banbury Oxfordshire (GB)

(21) Appl. No.: 16/498,717

(22) PCT Filed: Mar. 27, 2018
(86) PCT No.: PCT/GB2018/050798

§ 371 Date: Sep. 27, 2019

(30) Foreign Application Priority Data
Mar. 27, 2017 (GB) 1704849.7

(51) Int. Cl. B60W 30/02; B60L 15/20

(52) U.S. Cl. CPC B60W 30/02; B60L 15/20; B60W 2710/083; B60W 2520/14; B60W 2520/263; B60L 2220/46

(57) ABSTRACT

A method of controlling a vehicle is disclosed, comprising steps of: obtaining a current value of a slip angle of the vehicle; setting a reference yaw rate in accordance with the obtained slip angle; setting a reference yaw moment based on the reference yaw rate; and controlling the electric vehicle to apply torque to a plurality of wheels of the vehicle in accordance with the reference yaw moment. By using a slip angle to set the reference yaw rate, embodiments of the present invention can remove the need to estimate the tyre-road coefficient of friction. Apparatus for performing the method is also disclosed.

### TECHNICAL FIELD

The present invention relates to controlling a vehicle. In particular, the present invention relates to methods and apparatus for obtaining a reference yaw rate and controlling the vehicle according to the reference yaw rate.

### BACKGROUND

Electric vehicles are known in which wheels on opposite sides of the vehicle are provided with their own dedicated electric motors. This arrangement allows wheels on opposite sides of the vehicle to be driven independently from one another, and allows a different torque to be applied to each wheel. The process of determining how to allocate the available torque amongst the wheels is referred to as torque allocation.

Methods of performing torque allocation have been developed which can take into account a reference yaw rate, which is a yaw rate that the vehicle attempts to achieve in order to maintain stable handling or to improve the cornering response. However, determining the reference yaw rate requires the coefficient of friction between the tyres and the road surface to be estimated, which can be a complex and unreliable procedure. In real-world operating conditions it is difficult to estimate the tyre-road coefficient of friction accurately. Accordingly, the accuracy of the estimate can be poor, and as a result the reference yaw rate may not be suitable for the current friction conditions. At best this may result in unpredictable handling, and at worst this could result in loss of control of the vehicle, resulting in an accident.

The invention is made in this context.

### SUMMARY OF THE INVENTION

According to a first aspect of the present invention, there is provided a method of controlling a vehicle, the method comprising obtaining a current value of a slip angle of the vehicle, setting a reference yaw rate in accordance with the obtained slip angle, setting a reference yaw moment based on the reference yaw rate, and controlling the vehicle to apply torque to a plurality of wheels of the vehicle in accordance with the reference yaw moment.

In some embodiments according to the first aspect, the slip angle is a rear wheel slip angle measured in line with a rear axle of the vehicle. In another embodiment, the slip angle may be a rear wheel slip angle determined based on a measurement of a slip angle at a point away from a rear axle of the vehicle.

In some embodiments, instead of directly measuring the slip angle, the current value of the slip angle can be obtained by deriving an estimated slip angle based on measurements of one or more other physical quantities. For example, an estimated slip angle may be derived based on the current steering angle, yaw rate, lateral acceleration and forward acceleration.

In some embodiments according to the first aspect, the reference yaw rate is set by setting a higher reference yaw rate for a lower slip angle, and setting a lower reference yaw rate for a higher slip angle.

In some embodiments according to the first aspect, if the magnitude of the slip angle is less than a first threshold angle, the reference yaw rate is set to be equal to a predefined yaw rate. Here, the magnitude of the slip angle refers to the absolute value, also referred to as the modulus, of the slip angle.

In some embodiments according to the first aspect, in response to the magnitude of the slip angle being less than the first threshold angle, the method further comprises determining a current operating condition of the vehicle, and selecting one of a plurality of stored predefined yaw rate values as the reference yaw rate, each of the stored yaw rate values being associated with a different operating condition, by retrieving the stored yaw rate value associated with the current operating condition. The operating condition may be defined, for example, by one or more parameters including at least a steering angle and a vehicle speed.

In some embodiments according to the first aspect, if the magnitude of the slip angle is greater than a second threshold angle, the method further comprises determining a limited yaw rate based on a current lateral acceleration of the vehicle, and setting the reference yaw rate equal to the limited yaw rate.

In some embodiments according to the first aspect, in response to the magnitude of the slip angle being between the first and second threshold angles, the reference yaw rate is set as a weighted average of the predefined yaw rate and the limited yaw rate.

In some embodiments according to the first aspect, the reference yaw rate r_{ref} is calculated as:

r_{ref}=rₙw_{β}+rₗ(1−w_{β})

where rₙ is the predefined yaw rate, rₗ is the limited yaw rate, and w_{β} is a weighting factor dependent on the rear wheel slideslip angle.

In some embodiments according to the first aspect, the weighting factor is determined as:

$${w}_{β} = \frac{{β}_{th} - \vert {β}_{r} \vert}{{β}_{th} - {β}_{act}}$$

where β_{act} is the first threshold angle, βₜₕ, is the second threshold angle, and βᵣ is the rear wheel slip angle.

According to a second aspect of the present invention, there is provided a computer-readable storage medium arranged to store computer program instructions which, when executed, perform a method according to the first aspect.

According to a third aspect of the present invention, there is provided apparatus for controlling a vehicle, the apparatus comprising a slip angle obtaining unit configured to obtain a current value of a slip angle of the vehicle, a reference yaw rate setting unit configured to set a reference yaw rate in accordance with the obtained slip angle, a reference yaw moment setting unit configured to set a reference yaw moment based on the reference yaw rate, and a vehicle control unit configured to control the vehicle to apply torque to a plurality of wheels of the vehicle in accordance with the reference yaw moment.

According to a fourth aspect of the present invention, there is provided apparatus for controlling a vehicle, the apparatus comprising one or more processors and computer-readable memory arranged to store computer program instructions which, when executed by the one or more processors, cause the one or more processors to: obtain a current value of a slip angle of the vehicle; set a reference yaw rate in accordance with the obtained slip angle; set a reference yaw moment based on the reference yaw rate; and control the vehicle to apply torque to a plurality of wheels of the vehicle in accordance with the reference yaw moment.

According to a fifth aspect of the present invention, there is provided a vehicle comprising the apparatus according to the third or fourth aspect.

### BRIEF DESCRIPTION OF THE DRAWINGS

Embodiments of the present invention will now be described, by way of example only, with reference to the accompanying drawings, in which:

FIG. 1 illustrates an electric vehicle according to an embodiment of the present invention;

FIG. 2 illustrates a yaw moment experienced by the electric vehicle when different levels of torque are applied on opposite sides of the vehicle, according to an embodiment of the present invention;

FIG. 3 illustrates notation used throughout this document to refer to certain vehicle dimensions and components of forces acting on the vehicle;

FIG. 4 is a flowchart showing a method of controlling an electric vehicle, according to an embodiment of the present invention;

FIG. 5 is a flowchart showing a method of setting the reference yaw rate, according to an embodiment of the present invention;

FIG. 6 is a graph plotting the reference yaw rate as a function of the rear wheel slip angle, according to an embodiment of the present invention;

FIG. 7 schematically illustrates the structure of a control unit for controlling an electric vehicle, according to an embodiment of the present invention.

### DETAILED DESCRIPTION

In the following detailed description, only certain exemplary embodiments of the present invention have been shown and described, simply by way of illustration. As those skilled in the art would realize, the described embodiments may be modified in various different ways, all without departing from the scope of the present invention. Accordingly, the drawings and description are to be regarded as illustrative in nature and not restrictive. Like reference numerals designate like elements throughout the specification.

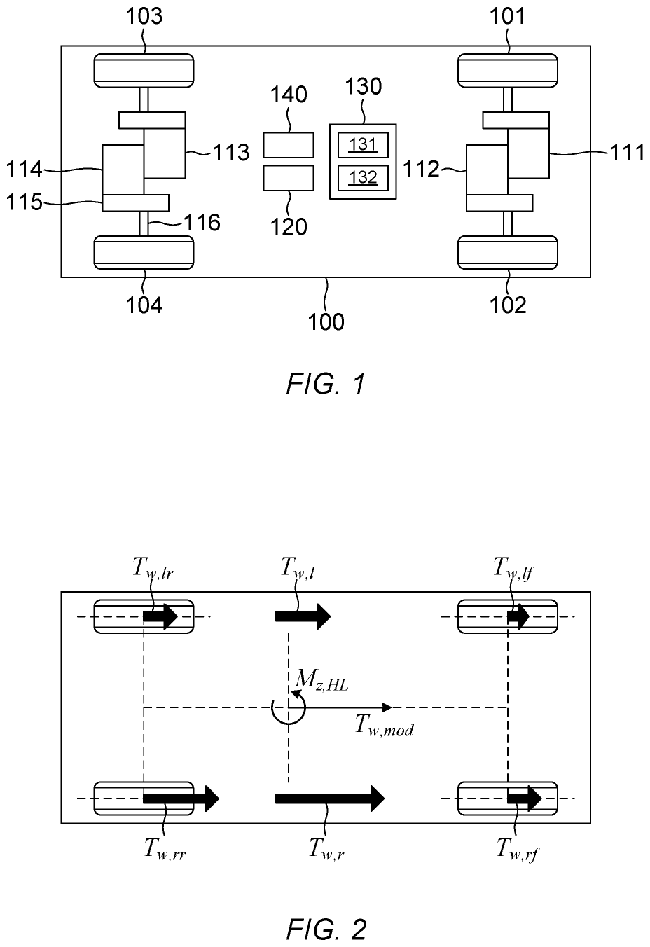

Referring now to FIG. 1, an electric vehicle is illustrated according to an embodiment of the present invention. In the present embodiment the vehicle 100 comprises four wheels 101, 102, 103, 104, and four electric motors 111, 112, 113, 114 each arranged to independently drive a respective one of the wheels 101, 102, 103, 104 via a gearbox 115 and axle 116. The wheels are arranged as a pair of front wheels 101, 102 and a pair of rear wheels 103, 104. However, other numbers of wheels and other arrangements are possible in other embodiments. In some embodiments additional axles may be provided and/or the vehicle may comprise an odd number of wheels, for example a pair of rear wheels and a single front wheel.

A wheel that is capable of being driven by an electric motor can be referred to as a ‘driven wheel’. In addition to a plurality of driven wheels, in some embodiments of the present invention a vehicle may further comprise one or more non-driven wheels which are not connected to an electric motor, but which instead rotate freely due to contact with the road surface while the vehicle is in motion. For example, in another embodiment of the present invention, the front wheels may be non-driven wheels and only the rear wheels may be driven by electric motors, or vice versa.

The plurality of motors 111, 112, 113, 114 can be controlled in order to impart a yaw moment on the electric vehicle 100. Here, ‘yaw’ is used in its conventional meaning, to refer to rotation of the vehicle about the vertical axis. For example, the plurality of motors 111, 112, 113, 114 can be controlled so as to apply a higher torque to the wheels on one side of the vehicle 100 than a torque that is applied to the wheels on the other side of the vehicle 100, with the result that a greater accelerating force is experienced by the vehicle 100 on the side on which the higher torque is applied. As a result, the vehicle 100 is subject to a moment about the vertical axis. This moment can be referred to as the yaw moment, and the vertical axis can be referred to as the yaw axis.

FIG. 2 illustrates a yaw moment M_{z,HL} experienced by the electric vehicle 100 when different levels of torque are applied on opposite sides of the vehicle 100. In FIG. 2, T_{w,rr} denotes the torque applied to the right rear wheel 104, T_{w,lr} denotes the torque applied to the left rear wheel 103, T_{w,rf} denotes the torque applied to the right front wheel 102, T_{w,lf} denotes the torque applied to the left front wheel 101, T_{w,r} denotes the total torque applied to the wheels 102, 104 on the right-hand side of the vehicle 100, T_{w,l} denotes the total torque applied to the wheels 101, 103 on the left-hand side of the vehicle 100, and T_{w,mod} denotes the total torque applied to all four wheels 101, 102, 103, 104 of the vehicle 100.

Continuing with reference to FIG. 1, the vehicle 100 further comprises a yaw rate sensor 120 arranged to measure the yaw rate of the vehicle 100, and a control unit 130 configured to determine a reference yaw moment for the vehicle 100 based on the error between the reference yaw rate and a yaw rate measurement obtained by the yaw rate sensor 120. The vehicle 100 further comprises a slip angle sensor 140 for measuring a slip angle of the vehicle 100. For example, the slip angle sensor 140 may be an optical sensor comprising one or more lasers pointed at the road surface, and arranged so as to measure a velocity component in the forward direction and a velocity component in the lateral direction. The slip angle β can then be derived by calculating the angle of the resultant velocity vector to the longitudinal axis of the vehicle 100.

The control unit 130 is further configured to determine a torque allocation based on the reference yaw moment, the torque allocation defining a torque to be applied to each of the plurality of wheels 101, 102, 103, 104, and control the plurality of electric motors 111, 112, 113, 114 to apply the determined torque allocation to the plurality of wheels 101, 102, 103, 104.

The yaw rate is the angular velocity of the rotation about the yaw axis, and is commonly expressed in terms of degrees per second or radians per second. The yaw rate sensor 120 can be any suitable type of yaw rate sensor, such as a piezoelectric sensor or micromechanical sensor. Examples of suitable yaw rate sensors are known in the art, and a detailed explanation of the operation of the yaw rate sensor 120 will not be provided here, so as to avoid obscuring the present inventive concept.

Depending on the embodiment, the control unit 130 may be implemented in hardware, for example using an application-specific integrated circuit (ASIC) or field-programmable gate array (FPGA), or may be implemented in software. In the present embodiment a software implementation is used, and the control unit 130 comprises a processing unit 131 and computer-readable memory 132 arranged to store computer programme instructions that can be executed by the processing unit 131 in order to determine the reference yaw rate. The processing unit 131 can comprise one or more processors.

The control unit 130 of the present embodiment is configured to determine the reference yaw rate in accordance with a rear wheel slip angle, βᵣ, which describes the amount of sideslip currently being experienced by the vehicle 100 in line with the rear axle 116. Depending on the embodiment, the rear wheel slip angle may be measured at a point in-line with the rear axle 116, or may be derived from a measurement of the slip angle at a certain distance from the rear axle 116, for example a measurement taken at the centre of gravity of the vehicle 100 by the slip angle sensor 140.

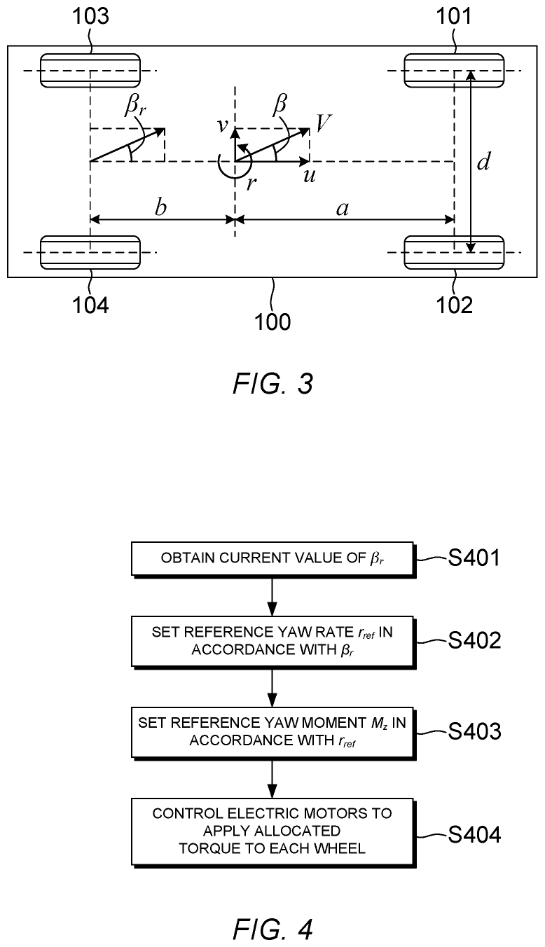

FIG. 3 illustrates notation used to refer to certain vehicle dimensions and components of forces acting on the vehicle 100. The following definitions are used throughout this document:
β=sideslip angle at centre of gravity of the vehicle
βᵣ=rear wheel slip angle
u=velocity component in forward direction
v=lateral velocity component
V=actual velocity of vehicle
r=vehicle yaw rate
a=distance between front axle and centre of gravity of the vehicle
b=distance between rear axle and centre of gravity of the vehicle
d=vehicle track width

Referring now to FIG. 4, a flowchart showing a method of controlling an electric vehicle is illustrated, according to an embodiment of the present invention. The flowchart illustrates steps performed by the control unit 130. In the present embodiment, the slip angle sensor 140 is used to measure the sideslip angle at the centre of gravity of the vehicle 100, β. In step S401, the control unit 130 obtains the slip angle β from the slip angle sensor 140, and derives the rear wheel slip angle βᵣ from β as follows:

$${β}_{r} = β - \frac{br}{V}$$

As explained above, in another embodiment the sideslip angle may be measured at the rear axle, in which case in step S401 the control unit 130 can obtain the rear wheel slip angle βᵣ directly from the slip angle sensor 140. In another embodiment, the reference yaw rate could be set in accordance with a slip angle β measured at a point away from the rear axle 116 without a step of deriving the rear wheel slip angle βᵣ. In yet another embodiment, the slip angle sensor 140 may be omitted, and the slip angle β may be derived from other vehicle parameters such as the steering angle, yaw rate, lateral acceleration and forward acceleration.

Next, in step S402 the control unit 130 sets a reference yaw rate r_{ref} in accordance with the obtained value of the rear wheel slip angle βᵣ. The reference yaw rate r_{ref} is a yaw rate that is deemed to be appropriate for the vehicle handling characteristics and the current friction conditions at the wheels. In step S403 the control unit 130 proceeds to set a reference yaw moment in accordance with the reference yaw rate r_{ref}. The torque allocation defines a torque to be applied to each one of the plurality of wheels 101, 102, 103, 104. Then, in step S404 the control unit 130 proceeds to determine a torque allocation in accordance with the error between the measure yaw rate r and the reference yaw rate r_{ref}, and control the plurality of electric motors 111, 112, 113, 114 to apply the allocated torque to each of the wheels 101, 102, 103, 104.

When determining the torque allocation in step S404, the control unit 130 attempts to allocate the available torque among the wheels 101, 102, 103, 104 so as to bring the actual observed yaw rate r closer to the reference yaw rate r_{ref}. In this way, the reference yaw rate r_{ref} is used as a target value which the control unit 130 attempts to achieve by changing the torque allocation. As explained above in relation to FIG. 2, a yaw moment can be exerted on the vehicle 100 by applying different levels of torque to the wheels 101, 102, 103, 104.

Conventionally, a reference yaw rate is set based on an estimate of the tyre-road friction coefficient. Estimating the tyre-road friction coefficient can be complex and unreliable, meaning that the reference yaw rate may not actually be appropriate for the current friction conditions at the wheels. In embodiments of the present invention, the control unit 130 can use the rear wheel slip angle βᵣ as an indicator of the criticality of the vehicle cornering conditions, avoiding the need to estimate the tyre-road friction coefficient altogether. This is possible because the rear wheel slip angle βᵣ is inherently related to the friction conditions at the rear wheels, and therefore conveys useful information as to whether the rear wheels are currently in a high-friction or low-friction condition.

When the rear wheel slip angle βᵣ is low, the vehicle can safely be subjected to a higher yaw rate since there is more grip available, thereby achieving faster cornering speeds. On the other hand, when the rear wheel slip angle βᵣ is high, a lower yaw rate should be used in order to allow the rear wheels 103, 104 to regain grip on the road surface. The control unit 130 may therefore set a higher reference yaw rate for a lower slip angle, and may set a lower reference yaw rate for a higher slip angle.

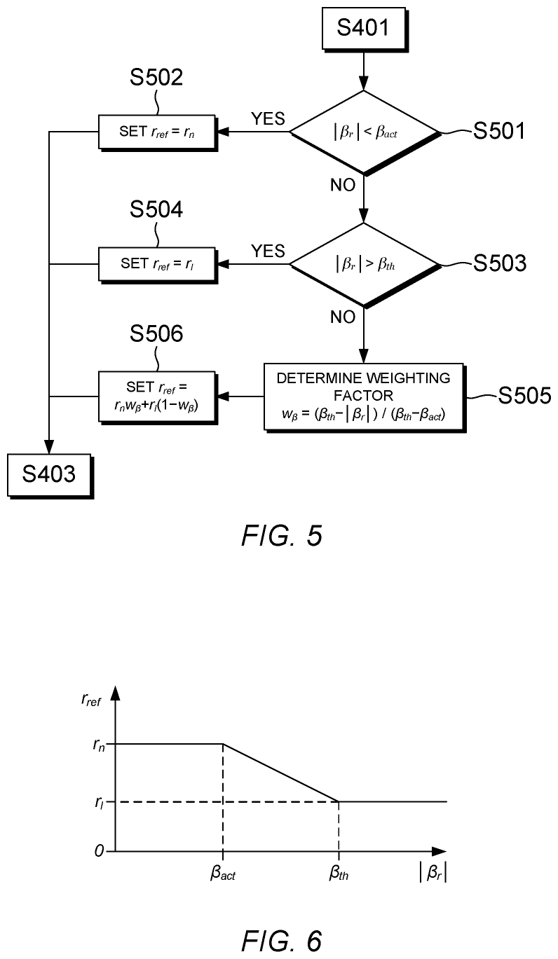

Referring now to FIG. 5, a flowchart showing a method of setting the reference yaw rate r_{ref} is illustrated, according to an embodiment of the present invention. In the present embodiment, the control unit 130 sets the reference yaw rate r_{ref} based on the sideslip angle of the rear wheels βᵣ, a nominal yaw rate rₙ, and a limited yaw rate rₗ. The steps illustrated in FIG. 5 may be performed during step S402 of the flowchart shown in FIG. 4. However, in other embodiments a different method of setting the reference yaw rate in step S402 could be used, instead of the one shown in FIG. 5. For example, in another embodiment a plurality of quantized values of the limited yaw rate rₗ could be calculated in advance and stored in a look-up table, each limited yaw rate rₗ being associated with a different lateral acceleration.

First, in step S501 the control unit 130 checks whether the rear wheel slip angle βᵣ is less than a first threshold angle β_{act}. In the present embodiment the rear wheel slip angle βᵣ may be positive or negative depending on whether the rear axle is undergoing sideslip to the left or to the right of the vehicle, and so in step S501 the modulus of the rear wheel slip angle βᵣ is compared to the first threshold angle β_{act}. In response to the rear wheel slip angle βᵣ being below the first threshold angle β_{act}, the control unit 130 proceeds to step S502 and sets the reference yaw rate r_{ref} to be equal to the nominal yaw rate rₙ.

The nominal yaw rate rₙ, which may also be referred to as the ‘handling yaw rate’, is a yaw rate that is suitable for the vehicle when operating in high-friction steady state conditions. Values of the nominal yaw rate rₙ can be calculated in advance for different operating conditions. The operating condition may be defined by one or more parameters, including at least the steering angle and the vehicle speed, and optionally including the longitudinal acceleration aₓ. A plurality of predefined values of the nominal yaw rate rₙ can be stored in a look-up table in the memory 132 of the control unit, each of the predefined values being associated with a different operating condition. In step S502, the control unit 130 can then determine the current operating condition of the electric vehicle, for example by obtaining current values of any parameters used to define the operating condition, and retrieve the stored yaw rate value that is associated with the current operating condition. The retrieved value of the nominal yaw rate, rₙ, is then used as the reference yaw rate r_{ref}.

If the rear wheel slip angle βᵣ is above the first threshold angle β_{act}, then the control unit 130 proceeds to step S503 and checks whether the rear wheel slip angle βᵣ is above a second threshold angle βₜₕ. The second threshold angle βₜₕ is higher than the first threshold angle β_{act}. If the rear wheel slip angle βᵣ is above the second threshold angle βₜₕ, then in step S504 the control unit 130 sets the reference yaw rate r_{ref} to be equal to a limited yaw rate rₗ.

The limited yaw rate rₗ, which may also be referred to as the ‘stability yaw rate’, is a yaw rate that is compatible with the current tyre-road friction conditions. In the present embodiment, the limited yaw rate rₗ is determined based on the lateral acceleration a_{y} of the electric vehicle 100, as follows:

$${r}_{l} = \{ \begin{matrix}\vert {r}_{sat} \vert sign ( {r}_{n} ) & if \vert {r}_{sat} \vert < \vert {r}_{h} \vert \\ {r}_{n} & if \vert {r}_{sat} \vert \geq \vert {r}_{h} \vert\end{matrix}$$

where the lateral acceleration a_{y} is the acceleration in the lateral direction, that is to say, the acceleration in a direction perpendicular to the direction of travel in the horizontal plane, and where:

$${r}_{sat} = \frac{{a}_{y} - sign ( {a}_{y} ) Δ {a}_{y}}{V}$$

In the present embodiment, the offset Δa_{y} provides a certain safety factor in the calculation of rₛₐₜ, ensuring that a conservative value is obtained for the limited yaw rate rₗ. In other embodiments a different method of determining the limited yaw rate rₗ may be used. For example, in another embodiment the limited yaw rate rₛₐₜ may be determined as a fixed percentage of the lateral acceleration divided by the velocity, for example 0.8a_{y}/V or 0.9a_{y}/V.

If the rear wheel slip angle βᵣ is below the second threshold angle βₜₕ, then the rear wheel slip angle βᵣ must lie somewhere between the two thresholds, or may be equal to one of the threshold angles. In this case, the control unit 130 proceeds to step S505 and obtains a weighting factor w_{β} based on the current value of the rear wheel slip angle βᵣ. In the present embodiment, the weighting factor w_{β} may vary continuously from 1 to 0 as the rear wheel slip angle βᵣ moves between the first and second thresholds β_{act}, βₜₕ, and is calculated as follows:

$${w}_{β} = \frac{{β}_{th} - \vert {β}_{R} \vert}{{β}_{th} - {β}_{act}}$$

The values of the first and second thresholds β_{act}, βₜₕ may be set according to the desired handling characteristics of the vehicle. For example, the first threshold β_{act}, may be set to approximately 3 degrees, and the second threshold angle βₜₕ may be set to approximately 7 degrees. These are merely examples, and in other embodiments other values may be used. For example, in another embodiment one or both of the first and second thresholds β_{act}, βₜₕ may be set to a higher value in order to produce a controlled drift.

Although in the present embodiment the weighting factor w_{β} may take any value between 0 and 1, in other embodiments the weighting factor w_{β} may be selected from one of a plurality of discrete values each associated with a certain range of rear wheel slip angles βᵣ. The plurality of values of w_{β} may be stored in memory in a look-up table, with the current value of βᵣ being used to retrieve the corresponding weighting factor w_{β}. Furthermore, although in the present embodiment the rear wheel slip angle βᵣ is used, in other embodiments a weighting factor may be determined based on a measurement of a slip angle β at a point away from the rear axle 116, by setting different thresholds accordingly.

Once the weighting factor w_{β} has been determined, then in step S506 the reference yaw rate r_{ref} is calculated as a weighted average of the nominal yaw rate rₙ and the limited yaw rate rₗ, as follows:

r_{ref}=rₙw_{β}+rₗ(1−w_{β})

A graph plotting the reference yaw rate as a function of the rear wheel slip angle is illustrated in FIG. 6, according to the present embodiment. By calculating r_{ref} as a weighted average between the upper and lower rear wheel slip angle thresholds, β_{act}, βₜₕ, a smooth transition is provided between the nominal yaw rate rₙ and the limited yaw rate rₗ.

In other embodiments a different approach may be used when setting the reference yaw rate r_{ref} based on the rear wheel slip angle βᵣ. For example, instead of setting upper and lower thresholds of the rear wheel slip angle, a single threshold may be defined, with the reference yaw rate r_{ref} being set equal to the nominal yaw rate rₙ above the threshold and set equal to the limited yaw rate rₗ below the threshold, resulting in a step change in the reference yaw rate. However, in the present embodiment the reference yaw rate r_{ref} is defined so as to provide a gradual transition as the rear wheel slip angle βᵣ increases or decreases, in order to avoid creating significant yaw rate vibrations that might otherwise result from a step-change in the reference yaw rate r_{ref}.

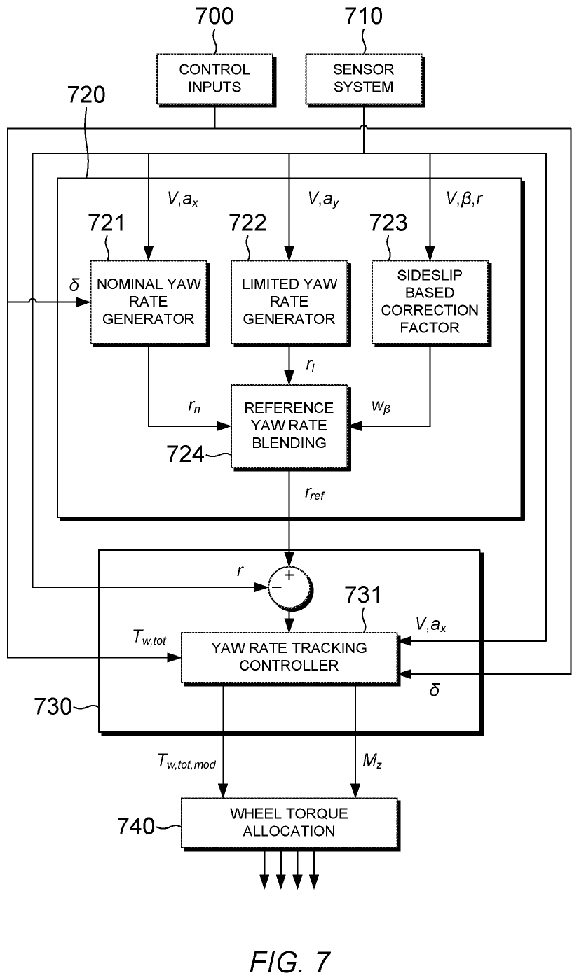

Referring now to FIG. 7, the structure of a control unit for controlling an electric vehicle is illustrated, according to an embodiment of the present invention. The diagram shown in FIG. 7 is intended to convey an understanding of the flow of information within the apparatus, and the operations that are performed. It should be understood that the structure shown in FIG. 7 is provided for illustrative purposes only, and should not be construed as implying a particular physical layout or separation of functions between physical components. For example, certain elements shown in FIG. 7 may be implemented in hardware whilst other elements may be implemented in software.

The apparatus is configured to receive control inputs 700 in the form of a total torque demand T_{w,tot} and steering angle δ, and sensor inputs from a sensor system 710. In the present embodiment the sensor inputs include the rear wheel slip angle βᵣ, the vehicle velocity V, the lateral acceleration a_{y}, the longitudinal acceleration aₓ, and the measured yaw rate r. The apparatus further comprises a reference yaw rate setting unit 720 that is configured to set the reference yaw rate r_{ref} in accordance with the obtained rear wheel slideslip angle βᵣ. In the present embodiment the reference yaw rate setting unit 720 is configured to use the method shown in FIG. 5 to set the reference yaw rate r_{ref}, and comprises a nominal yaw rate generator 721 configured to determine the nominal yaw rate rₙ based on the steering angle δ, velocity V and longitudinal acceleration aₓ, a limited yaw rate generator 722 configured to determine the limited yaw rate rₗ based on the velocity V and lateral acceleration a_{y}, a weighting factor calculating unit 723 configured to calculate the sideslip-based correction factor w_{β}, and a reference yaw rate calculator 724 configured to determine the reference yaw rate r_{ref} based on the nominal yaw rate rₙ, limited yaw rate rₗ, and the weighting factor w_{β}.

The nominal yaw rate generator 721 can be used to generate an appropriate nominal yaw rate rₙ according to the current operating conditions, for example by retrieving a predefined nominal yaw rate rₙ from a look-up table, as described above in relation to step S502 of FIG. 5. The limited yaw rate generator 722 can be used to generate an appropriate limited yaw rate rₗ according to the lateral acceleration, as described above in relation to step S504 of FIG. 5. The weighting factor calculating unit 723 can be used to calculate the weighting factor w_{β} when the rear wheel slip angle βᵣ is between the upper and lower threshold angles β_{act}, βₜₕ, as described above with reference to step S505 of FIG. 5. The reference yaw rate calculator 724 can be used to set the reference yaw rate r_{ref}, if necessary by computing a weighted average as described above with reference to step S506 of FIG. 5.

The apparatus further comprises a reference yaw moment setting unit 730 configured to set the reference yaw moment M_{z} in accordance with the reference yaw rate r_{ref}, based on the error between the reference yaw rate r_{ref} and the measured yaw rate r and the total wheel torque demand T_{w,tot}. In the present embodiment the reference yaw moment setting unit 730 comprises a feedback plus feedforward yaw rate tracking controller 731 which is configured to receive feedforward inputs including the vehicle velocity V, longitudinal acceleration aₓ, and steering angle δ. In other embodiments the reference yaw moment may be set using only feedback control, rather than feedback and feedforward control as in the present embodiment. The input parameters may be selected in accordance with the chosen control algorithm.

The apparatus further comprises a vehicle control unit 740 configured to allocate torque to different wheels of the vehicle 100, and to control the electric vehicle 100 to apply the determined torque allocation to the plurality of wheels 101, 102, 103, 104.

Although embodiments of the present invention have been described in relation to electric vehicles, it will be understood that the principles disclosed herein may readily be applied to other types of vehicles which are capable of controlling the level of torque applied to different wheels, for example vehicles with petrol, diesel, LPG (liquid petroleum gas) or hybrid propulsion systems.

Whilst certain embodiments of the invention have been described herein with reference to the drawings, it will be understood that many variations and modifications will be possible without departing from the scope of the invention as defined in the accompanying claims.

1. A method of controlling a vehicle, the method comprising:
obtaining a current value of a slip angle of the vehicle;
setting a reference yaw rate in accordance with the obtained slip angle;
setting a reference yaw moment based on the reference yaw rate; and
controlling the vehicle to apply torque to a plurality of wheels of the vehicle in accordance with the reference yaw moment.

2. The method of claim 1, wherein the slip angle is a rear wheel slip angle measured in line with a rear axle of the electric vehicle.

3. The method of claim 1, wherein the slip angle is a rear wheel slip angle determined based on a measurement of a slip angle at a point away from a rear axle of the electric vehicle.

4. The method of claim 1, wherein the current value of the slip angle is obtained by deriving an estimated slip angle based on measurements of one or more other physical quantities.

5. The method of claim 1, wherein the reference yaw rate is set by setting a higher reference yaw rate for a lower slip angle, and setting a lower reference yaw rate for a higher slip angle.

6. The method of claim 5, wherein if the magnitude of the slip angle is less than a first threshold angle, the reference yaw rate is set to be equal to a predefined yaw rate.

7. The method of claim 6, wherein in response to the magnitude of the slip angle being less than the first threshold angle, the method further comprises:
determining a current operating condition of the vehicle; and
selecting one of a plurality of stored predefined yaw rate values as the reference yaw rate, each of the stored yaw rate values being associated with a different operating condition, by retrieving the stored yaw rate value associated with the current operating condition.

8. The method of claim 7, wherein the operating condition is defined by one or more parameters including at least a steering angle and a vehicle speed.

9. The method of claim 6, wherein if the magnitude of the slip angle is greater than a second threshold angle, the method further comprises:
determining a limited yaw rate based on a current lateral acceleration of the vehicle; and
setting the reference yaw rate equal to the limited yaw rate.

10. The method of claim 9, wherein in response to the magnitude of the slip angle being between the first and second threshold angles, the reference yaw rate is set as a weighted average of the predefined yaw rate and the limited yaw rate.

11. The method of claim 10, wherein the reference yaw rate r_{ref} is calculated as:
r_{ref}=rₙW_{β}+rₗ(1−W_{β})
where rn is the predefined yaw rate, rz is the limited yaw rate, and w/3 is a weighting factor dependent on the rear wheel slideslip angle.

12. The method of claim 11, wherein the weighting factor is determined as:
$${w}_{β} = \frac{{β}_{th} - \vert {β}_{R} \vert}{{β}_{th} - {β}_{act}}$$
where β_{act} is the first threshold angle, βₜₕ is the second threshold angle, and βᵣ is the rear wheel slip angle.

13. A computer-readable storage medium arranged to store computer program instructions which, when executed, perform the method claim 1 recites.

14. Apparatus for controlling a vehicle, the apparatus comprising:
a slip angle obtaining unit configured to obtain a current value of a slip angle of the vehicle;
a reference yaw rate setting unit configured to set a reference yaw rate in accordance with the obtained slip angle;
a reference yaw moment setting unit configured to set a reference yaw moment based on the reference yaw rate; and
a vehicle control unit configured to control the vehicle to apply torque to a plurality of wheels of the vehicle in accordance with the reference yaw moment.

15. Apparatus for controlling a vehicle, the apparatus comprising:
one or more processors; and
computer-readable memory arranged to store computer program instructions which, when executed by the one or more processors, cause the one or more processors to:
obtain a current value of a slip angle of the vehicle;
set a reference yaw rate in accordance with the obtained slip angle;
set a reference yaw moment based on the reference yaw rate; and
control the vehicle to apply torque to a plurality of wheels of the vehicle in accordance with the reference yaw moment.

16. A vehicle comprising the apparatus of claim 14.
